(19) United States
(12) Patent Application Publication
(10) Pub. No.: US 2018/0343200 A1
(43) Pub. Date: Nov. 29, 2018

(54) CONGESTION CONTROL AND MESSAGE ANALYSIS IN A WIRELESS MESH NETWORK

(71) Applicant: QUALCOMM Incorporated, San Diego, CA (US)

(72) Inventors: Sourabh JANA, Bangalore (IN); Ravi SHEKHAR, Bangalore (IN)

(21) Appl. No.: 15/607,417

(22) Filed: May 26, 2017

(51) Int. Cl. H04L 12/801; H04L 12/26; H04L 12/841

(52) U.S. Cl. CPC H04L 47/12; H04L 47/11; H04L 47/22; H04L 47/286; H04L 43/0876

(57) ABSTRACT

The disclosure generally relates to congestion control, message analysis, and other improvements in a wireless mesh network. For example, according to various aspects, one or more devices in the wireless mesh network may be configured as monitoring nodes and a graph representing a message flow path in at least a portion of the wireless mesh network may be generated based at least in part on information related to one or more messages observed at the monitoring nodes. The graph can then be used to identify a path used to relay a message from at least one destination node to at least one source node (e.g., via one or more intermediate nodes). As such, a time-to-live (TTL) value to be used in messages communicated between the source node and the destination node can be appropriately configured based on a hop count between the source node and the destination node.

### TECHNICAL FIELD

The various aspects and embodiments described herein generally relate to wireless communications, and in particular, to congestion control, message analysis, and other improvements in a wireless mesh network.

### BACKGROUND

All wireless networking technologies generally have a limited range. However, there are many environments in which devices that are otherwise outside communication range may need to communicate using a reliable low-power wireless technology. For example, the Internet of Things (IoT) is based on the idea that everyday objects, not just computers and computer networks, can be read, recognized, located, addressed, and otherwise controlled via an IoT communications network (e.g., an ad-hoc system or the Internet). One way to address issues that arise when devices are outside a maximum communication range is to implement a mesh network, which has a topology in which all devices can communicate with each other either directly or indirectly. For example, two devices that are in radio range may communicate directly, whereas communication with devices located outside radio range may be achieved via one or more intermediate “relay” nodes. Mesh networks may therefore offer multiple paths to route a message from a source to a destination, resulting in greater reliability relative to other networks that tend to flow all traffic through a central hub (e.g., a router or gateway).

Accordingly, a wireless mesh network may generally refer to a network in which various devices or nodes have the ability to receive and act upon messages in addition to having the ability to repeat or relay the messages to surrounding devices or nodes that are within radio range. The mesh architecture may therefore extend the effective radio range associated with whatever wireless technology is used to convey the messages, whereby the mesh architecture can be used to implement the IoT and other suitable use cases that are built at least in part on wireless communications. In general, a wireless mesh network can use a routing protocol to find a path to convey a message from one node to another. Alternatively and/or additionally, a flooding protocol may be used. In a flooding protocol, each node may send a message to every other node in radio range, and the other nodes may in turn relay the message to each node in radio range thereof. Consequently, the message may be suitably relayed to all nodes in the mesh network. One advantage that may result from using a flooding approach is that less memory and processing power (and therefore less energy) may be required.

Although flooding may offer various advantages in a wireless mesh network, flooding protocols also present various challenges. For example, rather than using a time-synchronized flood protocol, some wireless technologies may use a naïve flooding protocol in which each message has to be sent to every other node arbitrarily even though some messages may only have one intended destination. As such, each node may eventually receive the same flooded message from each neighbor located at a next hop level. In that sense, the duplicate messages may increase the overall load as well as the processing complexity in the wireless mesh network. As the number of nodes in the wireless mesh network increases, using the naïve flooding protocol may be expected to result in decreased network reliability. One proposed approach to restrict the unlimited message circulation of a flooded message in a wireless mesh network is to use a message cache along with a hop count or time-to-live (TTL) value. However, in a large wireless mesh network, the message cache may be unable to eradicate flooding of duplicate messages. For example, when a transmitting node does not know the approximate hop count to a destination node, the transmitting node might choose a high TTL value. Furthermore, any relay nodes that transmit the flooded message to the originating/transmitting node may contribute to unnecessarily circulating the message.

Accordingly, there exists a need to develop devices, apparatus, and methods to control congestion and otherwise improve performance in a wireless mesh network.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

According to various aspects, a method for optimizing a wireless mesh network as described herein may comprise configuring one or more devices to be monitoring nodes in the wireless mesh network, wherein the monitoring nodes are selected from among a plurality of devices forming the wireless mesh network, generating a graph representing a message flow path in at least a portion of the wireless mesh network, the message flow path determined based at least in part on information related to one or more messages observed at the monitoring nodes, identifying, from the graph, at least one destination node and at least one source node that transmitted a message to the at least one destination node via one or more intermediate nodes, and configuring a time-to-live (TTL) value to be used in messages communicated between the at least one source node and the at least one destination node, the TTL value based at least in part on a hop count between the at least one source node and the at least one destination node.

According to various aspects, a controller device as described herein may comprise a transceiver configured to communicate via a wireless mesh network and a processor coupled to the transceiver and configured to configure one or more devices to be monitoring nodes in the wireless mesh network, the monitoring nodes selected from among a plurality of devices forming the wireless mesh network, generate a graph representing a message flow path in at least a portion of the wireless mesh network, the message flow path determined based at least in part on information related to one or more messages observed at the monitoring nodes, identify, from the graph, at least one destination node and at least one source node that transmitted a message to the at least one destination node via one or more intermediate nodes, and configure, via the transceiver, a time-to-live (TTL) value to be used in messages communicated between the at least one source node and the at least one destination node based at least in part on a hop count between the at least one source node and the at least one destination node.

According to various aspects, an apparatus as described herein may comprise means for selecting one or more devices to be configured as monitoring nodes in a wireless mesh network from among a plurality of devices forming the wireless mesh network, means for generating a graph representing a message flow path in at least a portion of the wireless mesh network, the message flow path determined based at least in part on information related to one or more messages observed at the monitoring nodes, means for identifying, from the graph, a destination node and a source node that transmitted a message to the destination node via one or more intermediate nodes, and means for configuring a TTL value to be used in messages communicated between the source node and the destination node, the TTL value based at least in part on a hop count between the source node and the destination node.

According to various aspects, a computer-readable storage medium as described herein may store computer-executable instructions configured to cause one or more processors to select one or more devices to be configured as monitoring nodes in a wireless mesh network from among a plurality of devices forming the wireless mesh network, generate a graph representing a message flow path in at least a portion of the wireless mesh network, the message flow path determined based at least in part on information related to one or more messages observed at the monitoring nodes, identify, from the graph, a destination node and a source node that transmitted a message to the destination node via one or more intermediate nodes, and configure a TTL value to be used in messages communicated between the source node and the destination node based at least in part on a hop count between the source node and the destination node.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of the various aspects and embodiments described herein and many attendant advantages thereof will be readily obtained as the same becomes better understood by reference to the following detailed description when considered in connection with the accompanying drawings which are presented solely for illustration and not limitation, and in which:

FIG. 1 illustrates an exemplary wireless mesh network in which the various aspects and embodiments described herein may be suitably implemented.

FIG. 2 illustrates an exemplary environment in which a wireless mesh network implementing the various aspects and embodiments described herein may be deployed.

FIG. 3 illustrates an exemplary network graph to depict a message flow path in a wireless mesh network that uses a flooding protocol, according to various aspects.

FIG. 4 illustrates exemplary packet structures that may be used to communicate messages in a wireless mesh network, according to various aspects.

FIG. 5 illustrates an exemplary method to select and configure monitoring node(s) to optimize traffic in a wireless mesh network, according to various aspects.

FIG. 6 illustrates an exemplary method to optimize traffic in a wireless mesh network based on information captured at one or more monitoring nodes, according to various aspects.

FIG. 7 illustrates exemplary network graphs to depict an initial state and a final state based on an optimized time-to-live (TTL) value, according to various aspects.

FIG. 8 illustrates exemplary network graphs to depict an initial state and a final state based on an optimized routing, according to various aspects.

FIG. 9 illustrates an exemplary network graph that can be used to detect critical nodes in a wireless mesh network, according to various aspects.

FIG. 10 illustrates an exemplary network graph that can be used to detect non-functional nodes in a wireless mesh network, according to various aspects.

FIG. 11 illustrates an exemplary network graph that can be used to configure node-specific routing tables in a wireless mesh network, according to various aspects.

FIG. 12 illustrates an exemplary device configured as a mesh network node in accordance with the various aspects and embodiments described herein.

### DETAILED DESCRIPTION

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage, or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects and/or embodiments may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

As used herein, the terms “user device,” “user equipment” (or “UE”), “user terminal,” “client device,” “communication device,” “wireless device,” “wireless communications device,” “handheld device,” “mobile device,” “mobile terminal,” “mobile station,” “handset,” “access terminal,” “subscriber device,” “subscriber terminal,” “subscriber station,” “terminal,” and variants thereof may interchangeably refer to any suitable mobile or stationary device. Accordingly, the above-mentioned terms may suitably refer to any one or all of cellular telephones, smart phones, personal or mobile multimedia players, personal data assistants, laptop computers, personal computers, tablet computers, smart books, palm-top computers, wireless electronic mail receivers, multimedia Internet-enabled cellular telephones, wireless gaming controllers, and similar devices with a programmable processor, memory, and circuitry to connect to and communicate over a radio access network (RAN) that implements a particular radio access technology (RAT), over a wired network, over a wireless local area network (WLAN) (e.g., based on IEEE 802.11, etc.), and/or with other devices via a direct device-to-device (D2D) or peer-to-peer (P2P) connection (e.g., a Bluetooth connection).

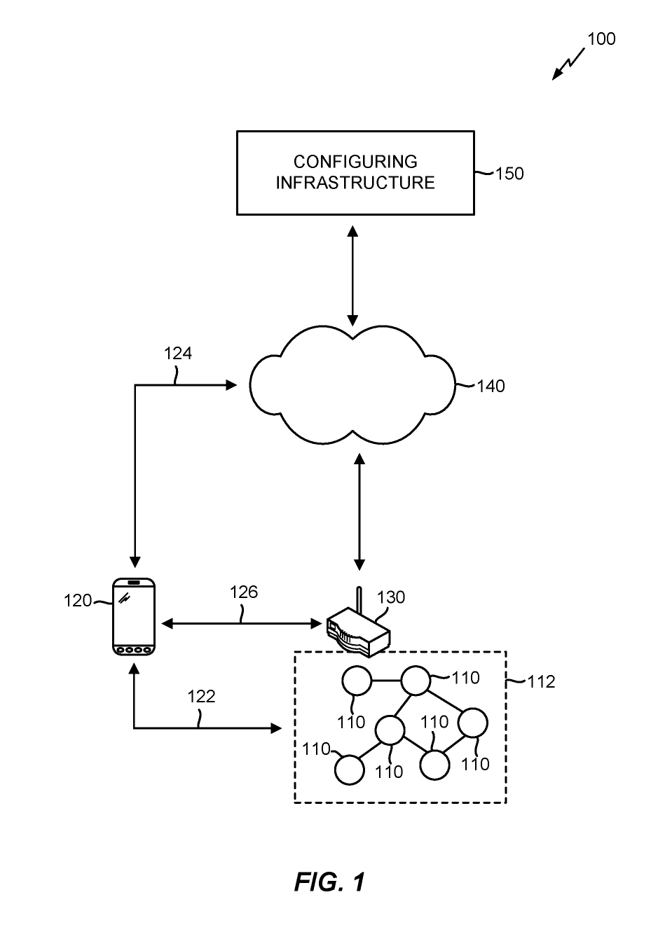

According to various aspects, FIG. 1 illustrates an exemplary wireless mesh network 100 in which the various aspects and embodiments described herein may be suitably implemented. More particularly, the example wireless mesh network 100 may comprise various nodes 110, which may optionally be organized as a group 112, a controller 120 (e.g., a mobile device), a gateway 130, and a configuring infrastructure 150 in communication via a network cloud 140. Furthermore, although the controller 120 and the gateway 130 are depicted in FIG. 1 as elements separate from the nodes 110, those skilled in the art will appreciate that the controller 120 and/or the gateway 130 can be included among the nodes 110 in various embodiments. In general, the nodes 110 may be the basic building blocks of the wireless mesh network 100, wherein the nodes 110 may comprise any suitable device that can be configured to send, receive, and relay messages to surrounding nodes 110 (i.e., devices). In various embodiments, message communication among the nodes 110 may generally be based on broadcast messages, which may be transmitted via one or more wireless channels.

According to various aspects, the controller 120 may be configured to establish a wireless connection 122 with the nodes 110, whereby the controller 120 may use a wireless radio to communicate with the nodes 110 in the wireless mesh network 100. Furthermore, in various embodiments, the controller 120 may have an additional communication path 124 to the wireless mesh network 100. For example, in various embodiments, the controller 120 may use a configuring application to communicate with the configuring infrastructure 150 via the additional communication path 124 (e.g., via a web console or service). As such, the configuring infrastructure 150 may service configuration commands received from the controller 120 (e.g., to securely distribute a network key to a new node 110, to program a particular node 110 to be within the group 112 or another group, etc.). In various embodiments, the gateway 130 may link the various nodes 110 to the network cloud 140 and allow command and control over a local area network (LAN) or wireless LAN (WLAN) to which the gateway 130 is connected. Like other elements in the wireless mesh network 100, the gateway 130 may also use a wireless radio to communicate with the various nodes 110 via a wireless channel. According to various aspects, the wireless mesh network 100 may enable the nodes 110 to send, receive, and/or relay messages (e.g., command and control operations), which may originate at one or more of the nodes 110 and/or be received from the controller 120 via the wireless connection 122 or from the gateway 130 via the additional communication path 124 between the controller 120 and the nodes 110.

According to various aspects, as will be described in further detail herein, the wireless mesh network 100 may use one or more monitoring nodes (or monitoring devices) to identify the number of nodes 110 present in the wireless mesh network 100 and create a network graph from a message flow path. The network graph may help to identify a message hop count and select an appropriate time-to-live (TTL) value that a transmitting node 110 should use when broadcasting a message, thus reducing unnecessary message circulation. For example, in various embodiments, the TTL value may be a field in a packet that contains the broadcasted message, wherein the TTL value may limit the number of times that the message can be relayed (e.g., each time that a node 110 receives and relays a message, the TTL value may be decremented by one (1), wherein a message with a TTL value of one (1) or zero (0) is not relayed). Furthermore, the monitoring node(s) can help to identify nodes 110 present at the same hop level so that a user can designate a subset of the nodes 110 to relay messages resulting in optimized routing. The monitoring node(s) may capture a timestamp of messages that are transmitted among the nodes 110 to determine an average amount of delay in message transmission, which may help to identify nodes 110 that are at junctions in the wireless mesh network 100 and therefore exposed to substantial mesh traffic (e.g., based on a message count indicating that certain nodes 110 are exposed to relatively more mesh messages than other nodes 110). The message flow path may also be used to identify non-functional nodes 110 such that a user can be alerted to take necessary measures and/or to locate devices that might be causing significant spurious transmissions in the wireless mesh network 100, which could lead to denial of service if left unaddressed. The message traffic may also be used to track important network operations occurring in the wireless mesh network 100.

According to various aspects, the monitoring node(s) may generally operate like a sniffer, in that the monitoring node(s) may sniff and analyze packets that are communicated in the wireless mesh network 100. As such, capturing mesh messages using a passive scan (or sniffing) function may advantageously avoid the need to inject any additional traffic into the wireless mesh network 100. In various embodiments, because the monitoring node(s) may need to have the ability to passively observe traffic in the wireless mesh network 100, the monitoring node(s) may be carefully selected to ensure that the monitoring node(s) have a sufficient radio range to listen to transmissions from as many of the nodes 110 as possible. Among other possible criteria, the monitoring node(s) may be chosen based on having sufficient processing capacity to analyze the captured mesh messages and understand the instantaneous topology and the instantaneous load in the wireless mesh network 100. Furthermore, the monitoring node(s) may be need to be stationary to ensure that mesh network traffic in a reference vicinity can be monitored for a substantial time. Considering these factors, the gateway 130 may typically be a suitable choice to perform the monitoring functions. As such, in various embodiments, the controller 120 may communicate with the gateway 130 over a direct point-to-point wireless connection 126 to help manage the monitoring functions. Alternatively and/or additionally, a specific node 110 may be designated to be a monitoring node at runtime and that decision can be periodically evaluated based on the logs that are captured at the configured monitoring node(s). For example, statistics related to messages received at each node 110 in a cluster or group 112 may be obtained and the node 110 with the maximum packet received count can be used to perform the monitoring functions. However, those skilled in the art will appreciate that the above factors are exemplary only and that other suitable criteria can be used.

According to various aspects, at least the nodes 110, the controller 120, and the gateway 130 may be configured to communicate with one another via a wireless mesh protocol, which may generally enable devices to send, receive, and relay messages to surrounding devices located within radio range, thus forming an ad-hoc mesh network. For example, message communication may be based on broadcast messages transmitted and received via one or more wireless channels (e.g., a Bluetooth broadcast channel), wherein each node 110 that receives a broadcast message may accept and forward the message to other nodes 110 within radio range. In this manner, the range over which the nodes 110 can communicate may be easily extended, as one or more intermediate nodes 110 can be used to relay a message to another node 110 that is otherwise located outside radio range. As such, the wireless mesh protocol may enable the wireless mesh network 100 to be easily extended to accommodate new devices, which can also increase the geographic coverage of the wireless mesh network 100 depending on device placement. The wireless mesh protocol can therefore be used to support various different use cases that are built, at least in part, on point-to-point, point-to-multipoint, and/or other suitable wireless communications.

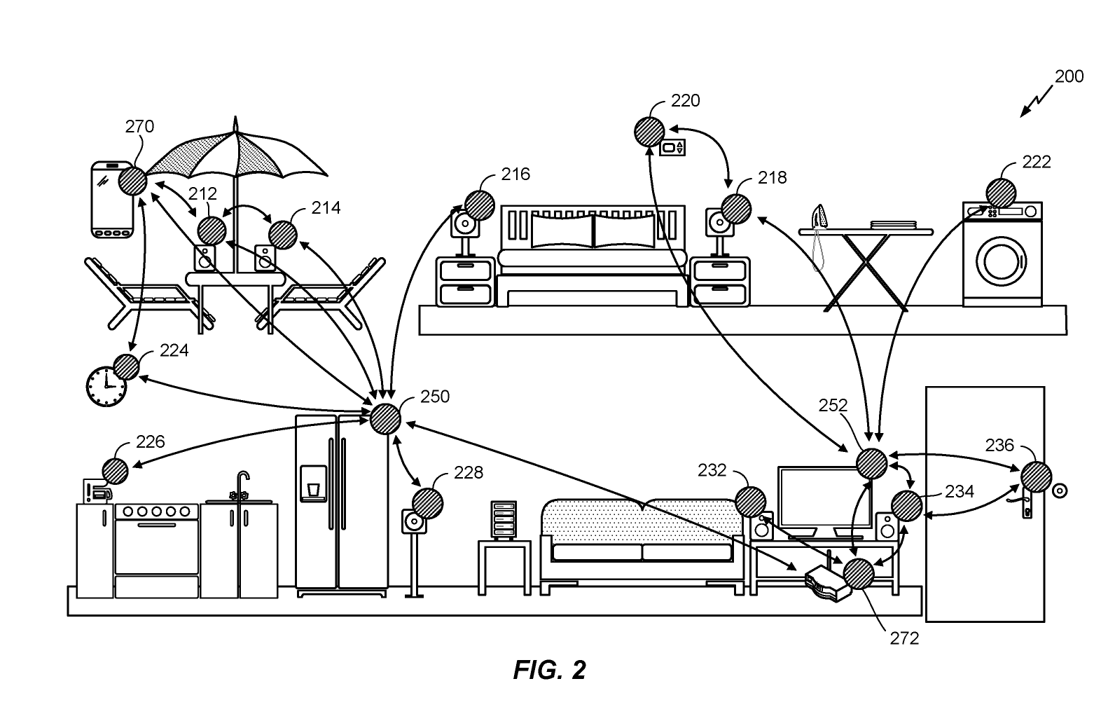

According to various aspects, FIG. 2 illustrates one exemplary environment 200 in which a wireless mesh network may be suitably implemented. In the exemplary environment 200 shown in FIG. 2, the wireless mesh network supports a home automation or Internet of Things (IoT) use case, where home appliance lights, electrical switches, thermostats, etc. can form a wireless mesh network and be controlled via the wireless mesh protocol, either directly using one or more user devices or indirectly via a gateway device in communication with the one or more user devices (e.g., a smartphone, a laptop computer, etc.). For example, the particular environment 200 as shown in FIG. 2 includes a smartphone 270, outdoor speakers 212, 214, bedroom speakers 216, 218, a thermostat 220, a laundry machine 222, a clock 224, a coffee machine 226, a refrigerator 250, a kitchen speaker 228, family room speakers 232, 234, a television 252, an electronic lock 236, and a home gateway device 272. The various devices may communicate with other devices within sufficient range (e.g., via broadcast messages) and the messages may be received and relayed as appropriate to ensure that the message(s) reach the intended destination. For example, in the environment 200 shown in FIG. 2, a user may press a button on the smartphone 270 to engage the electronic lock 236, which is located outside radio range from the smartphone 270. However, the smartphone 270 is within radio range from the outdoor speakers 212, 214, the clock 224, and the refrigerator 250. Accordingly, the smartphone 270 may broadcast a message containing a command to engage the electronic lock 236, and the outdoor speakers 212, 214, the clock 224, and the refrigerator 250 may each relay the message until the message eventually reaches the electronic lock 236.

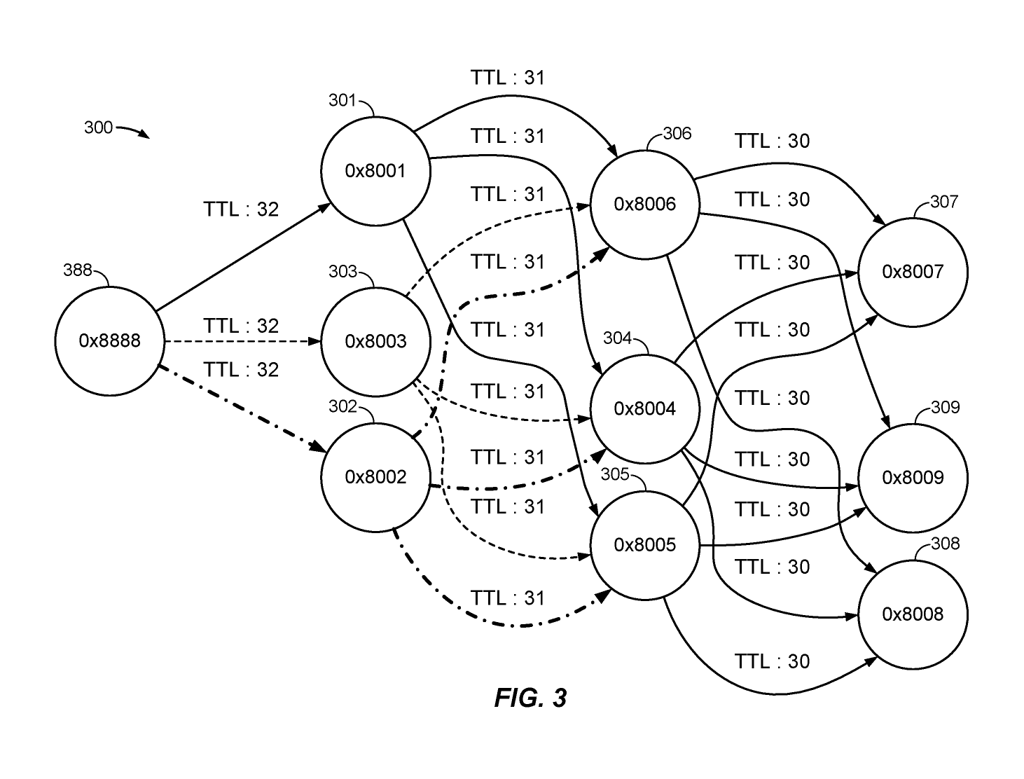

In various embodiments, as noted above, communication in the wireless mesh network 100 as shown in FIG. 1, the environment 200 as shown in FIG. 2, and/or other suitable mesh network environments may generally be based on a wireless mesh protocol. For example, in various embodiments, a routing protocol can be used to find a path to convey a message from one node in the wireless mesh network to another node in the wireless mesh network. Alternatively and/or additionally, a flooding protocol may be used. In a flooding protocol, each node may send a message to every other node in radio range, and the other nodes may in turn relay the message to each node in radio range thereof. Consequently, the message may be suitably relayed to all nodes in the wireless mesh network. For example, FIG. 3 illustrates an exemplary network graph 300 to depict a message flow path in a wireless mesh network that uses a flooding protocol.

More particularly, the example network graph 300 shown in FIG. 3 includes node 388 at a first hop level, nodes 301, 302, 303 at a second hop level, nodes 304, 305, 306 at a third hop level, and nodes 307, 308, 309 at a fourth hop level. As noted above, devices may generally broadcast messages in the wireless mesh network over a suitable wireless channel (e.g., a Bluetooth advertising channel). Messages may then be routed through the wireless mesh network using the flooding protocol with assistance from various nodes implementing relay functionality. For example, the node 388 at the first hop level may broadcast a message for which node 308 is the intended destination. The broadcasted message may therefore be received at the nodes 301, 302, 303 at the next hop level, which may each receive and relay the message to the nodes 304, 305, 306 at the next hop level and so on until the message reaches the intended destination node 308. Although flooding the message may advantageously offer simplicity and consume less memory and processing power (and therefore less energy), a naïve flooding protocol presents various challenges. For example, a naïve flooding protocol may promote duplicate messages because each message has to be arbitrarily sent to every other node even if the message only has one intended destination. As such, each node may eventually receive the same flooded message from each neighbor located at a next hop level. In that sense, the duplicate messages may increase the overall load as well as the processing complexity in the wireless mesh network. As the number of nodes in the wireless mesh network increases, using the naïve flooding protocol may be expected to result in greater and greater reductions in network reliability.

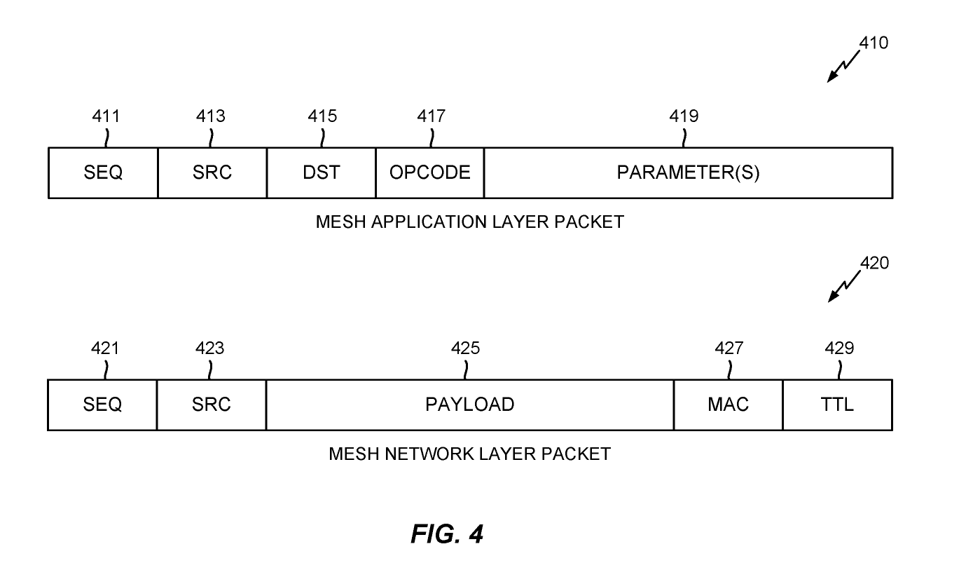

According to various aspects, one approach to restrict the unlimited message circulation of a flooded message in a wireless mesh network may be to use a message cache along with a hop count or time-to-live (TTL) value. For example, according to various aspects, FIG. 4 illustrates exemplary packet structures 410, 420 that may be used to communicate messages in a wireless mesh network. More particularly, FIG. 4 illustrates a mesh application layer packet 410, which may include a sequence (SEQ) number 411, a source (SRC) identifier 413 associated with a message originator, a destination (DST) identifier 415 associated with the originator, a message opcode 417, and one or more message parameters 419. Still referring to FIG. 4, a mesh network layer packet 420 may include a sequence (SEQ) number 421, a source (SRC) identifier 423, an encrypted payload 425, a message access code (MAC) 427, and a TTL value 429. For example, after the mesh application layer packet 410 has been encrypted and authenticated, the MAC 427 (e.g., an eight octet field) may be produced to confirm the integrity of the message. As such, if a message is identical to another message, the MAC 427 will also be identical. In the message cache solution mentioned above, a node may be configured to discard, without relaying, any message with a MAC 427 that matches the MAC 427 associated with a previous message stored in the message cache, which may help to reduce flooding. For example, referring to FIG. 3, the nodes 304, 305, 306 only relay the message from node 301 and do not relay the identical messages that are received from nodes 302, 303. However, in a large wireless mesh network, the message cache may be unable to eradicate flooding of duplicate messages. For example, constrained memory may be unable to maintain a large enough cache of messages to prevent duplication. Furthermore, when a transmitting node does not know the approximate hop count to a destination node, the transmitting node might choose an unnecessarily high TTL value 429, which would otherwise limit the number of times that the message can be relayed in the network (e.g., each time that a device receives and relays a message, the TTL value 429 is decremented by one without re-computing the MAC 427). Although the message would not be relayed when the TTL value 429 reaches one (1) (e.g., because a TTL value 429 of zero (0) is used to communicate with neighboring devices), this may also fail to reduce flooding. Users and/or applications may therefore select a suboptimal TTL value 429, as the size of a given wireless mesh network is not static, and instead set the TTL value 429 to the maximum value. For example, simple math suggests that a message that has to be relayed from a first level (L1) having a first number (N1) of nodes to a second level (L2) having a second number (N2) of nodes will result in N1*N2 messages transmitted from L1 to L2.

According to various aspects, as mentioned above, one or more devices in a wireless mesh network may be selected to be monitoring nodes in an effort to address at least the above-mentioned problems that may result from using a flooding protocol to communicate messages in a wireless mesh network. For example, the monitoring nodes may generally operate like a packet sniffer, whereby the monitoring nodes may be configured to sniff and analyze packets that are transmitted from node to node within the wireless mesh network. Among other things, the monitoring nodes may set suitable node-specific TTL values to help reduce unnecessary message flooding in a wireless mesh network, identify critical nodes and determine whether the critical nodes are becoming a bottleneck, identify failed or otherwise non-functional nodes that could jam the wireless mesh network and cause packet loss, and so on. For example, referring to FIG. 4 and as will be described in further detail herein, the monitoring nodes may be configured to inspect the various fields in a mesh application layer packet 410 and/or a mesh network layer packet 420 to determine and optimize the topology, load, and other information related to the wireless mesh network. For example, the MAC 427 that is generally used to confirm the integrity of a message can also be used to recognize identical messages, which may aid the analysis performed using the monitoring nodes.

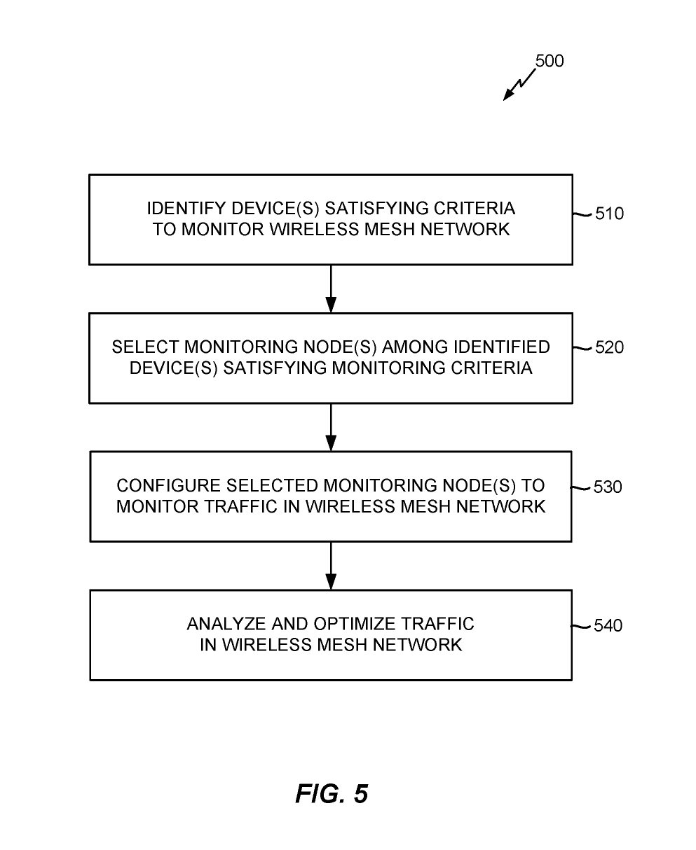

As such, according to various aspects, FIG. 5 illustrates an exemplary method 500 to select and configure appropriate monitoring node(s) to optimize traffic in a wireless mesh network. In various embodiments, the selected monitoring nodes may include a node within a node cluster, a device external to a node cluster, and/or any suitable combination thereof. In various embodiments, selecting the monitoring node(s) may begin at block 510, where one or more devices that satisfy criteria to monitor the wireless mesh network may be identified. For example, in various embodiments, the monitoring node(s) should ideally have a sufficient radio range to listen to transmissions from all nodes in the network or as many nodes as possible (e.g., in a large wireless mesh network, multiple monitoring nodes may need to work in cooperation to listen to transmissions from all nodes in the network). Furthermore, the monitoring node(s) should have sufficient processing capacity to optionally analyze the messages that are transmitted among the nodes in the wireless mesh network and should ideally be stationary to ensure that traffic in the wireless mesh network can be monitored in a reference vicinity for a substantial amount of time.

In various embodiments, at block 520, one or more monitoring nodes may therefore be identified from among the identified devices that best satisfy the applicable monitoring criteria. For example, a gateway device may be chosen to be the monitoring node because the gateway device is typically stationary, has sufficient radio range to communicate with many (if not all) devices in the wireless mesh network, and processing capacity to analyze the captured messages. In various embodiments, another possibility may be to select monitoring nodes suitable to monitor one or more portions of the wireless mesh network that have a greater clustering of nodes. For example, a mobile device or another suitable device can be used to identify and set a specific node to be a monitoring node at runtime and periodically reevaluate which node is best suited to perform the monitoring operations based on the messages captured from the configured monitoring node (e.g., statistics related to messages received at each node in a cluster may be obtained over a given time period and the node that can best perform the monitoring operations may be determined based on the node(s) with a maximum packet received count).

In various embodiments, after the one or more monitoring nodes have been appropriately selected, the monitoring nodes may be configured to monitor traffic in the wireless mesh network at block 530. For example, the wireless mesh network may be configured to encrypt and authenticate all messages that are transmitted therein to secure the communication against eavesdropping, wherein the encryption and authentication is generally performed using an encryption key distributed to all mesh nodes during the node installation process (sometimes alternatively referred to as provisioning or association). As such, to enable the monitoring nodes to capture and decrypt the mesh messages, configuring the monitoring nodes at block 530 may comprise provisioning the monitoring nodes with the same encryption key. Once configured, the monitoring nodes may then capture, analyze, and optimize traffic in the wireless mesh network at block 540. For example, as will be described in further detail below, the monitoring nodes may perform a passive scanning function to capture the mesh messages that are broadcasted within the wireless mesh network, wherein the captured mesh messages may be sent using a non-connectable advertisement that contains mesh network address (ADDR) associated with the transmitting device. Referring again to FIG. 4, a particular mesh message may be identified based on the MAC field 427, while the TTL field 429, the SRC fields 413, 423, and the DST fields 415 may be useful to help discovering the message flow path. Furthermore, in use cases where multiple monitoring nodes are used, the captured mesh messages may be pushed to the cloud where the mesh messages are further analyzed. For example, after the mesh message logs have been analyzed in the cloud, suggestions to improve throughput or otherwise optimize mesh network traffic may be sent to a controller device to allow a user to configure the mesh nodes or take other necessary actions (if needed).

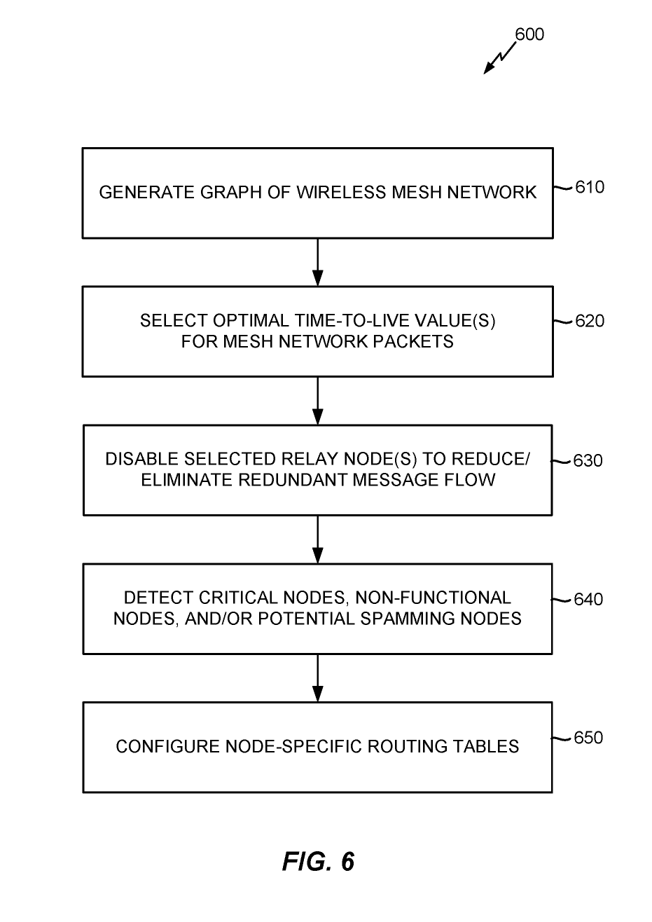

According to various aspects, referring now to FIG. 6, an exemplary method 600 to optimize traffic in a wireless mesh network based on information captured at one or more monitoring nodes is illustrated therein. Among other things, the method 600 may be used to select appropriate transmission parameters to improve efficiency over a wireless mesh network in which various nodes send, receive, and relay multi-hop messages, to select optimal nodes to perform relay functions, to identify critical nodes that are located at junction points and exposed to substantial mesh traffic, to identify non-functional nodes, to locate devices that might be causing spurious traffic, and to identify important operations that might be occurring in the wireless mesh network. The one or more monitoring nodes may be selected and configured as indicated above to help with understanding and analyzing mesh packet parameters, which will be explained in further detail below with reference to certain example mesh network logs.

In various embodiments, the mesh traffic analysis may at least include generating a mesh network graph at block 610 to represent the topology associated with the wireless mesh network. More particularly, in various embodiments, generating the mesh network graph at block 610 may comprise identifying a size associated with the wireless mesh network based on a number of active nodes that are detected in the network. The number of active nodes may be important to select a reliable TTL value to avoid redundant message circulation in the wireless mesh network. For example, as will be discussed below, if the wireless mesh network contains four (4) functional nodes, then a TTL value of four should be sufficient to communicate from one end of the wireless mesh network to the other end of the wireless mesh network. In various embodiments, the number of active nodes may be determined based on distinct addresses that appear in a mesh message log, which may distinguish different devices that are transmitting messages in the wireless mesh network. For example, from the example mesh network log shown in Table 1 below, six (6) distinct mesh devices can be identified. In particular, the messages received at times T3 and T7 have an identical device address (ADDR) and therefore represent one mesh device. Likewise, the messages received at times T2 and T8 have an identical ADDR and therefore represent one mesh device. The remaining four messages each have a distinct, non-repeating ADDR value, whereby the messages received at times T1, T4, T5, and T6 represent four distinct mesh devices.

TABLE 1
Example Mesh Network Log

| Time | ADDR | SRC | DST | MAC | TTL |
|---|---|---|---|---|---|
| T1 | 00025b014863 | 8888 | 8001 | d782f1367d1aa0e4 | 32 |
| T2 | 00025b0145ba | 8888 | 8001 | d782f1367d1aa0e4 | 31 |
| T3 | 00025b011c10 | 8888 | 8001 | d782f1367d1aa0e4 | 30 |
| T4 | 00025b001111 | 8001 | 8888 | 622685a564c152ee | 20 |
| T5 | 00025b011b20 | 8888 | 8001 | d782f1367d1aa0e4 | 30 |
| T6 | 00025b014211 | 8888 | 8001 | d782f1367d1aa0e4 | 29 |
| T7 | 00025b011c10 | 8001 | 8888 | 622685a564c152ee | 19 |
| T8 | 00025b0145ba | 8001 | 8888 | 622685a564c152ee | 18 |

In various embodiments, to generate the mesh network graph, block 610 may further comprise identifying the transmitting device (or node) associated with each captured mesh message. More particularly, among multiple messages that have the same MAC, the message that has a maximum TTL value may represent the original transmission. Accordingly, among multiple messages that have the same MAC, the originating device may be the device that transmitted one of the multiple messages that has the highest TTL value. For example, referring again to Table 1, the device with address 0x00025b014863 sent the message with the MAC value d782f1367d1aa0e4 and a TTL value of 32 to a destination device 0x8001, while other devices that sent the message with the MAC value d782f1367d1aa0e4 used a TTL value below 32. As such, in this example, the transmitting node is the device having the identifier 0x8888. In a similar respect, with respect to the message having the MAC value 622685a564c152ee, the highest TTL value is 20 sent from the node associated with address 00025b001111, which is therefore the device having the identifier 0x8001.

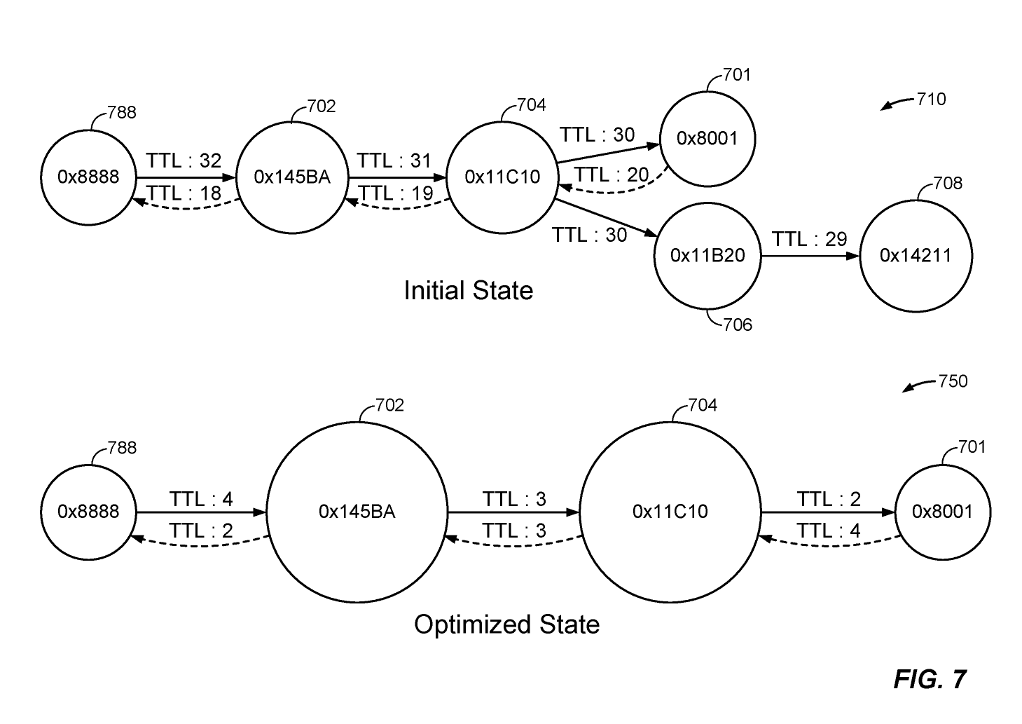

To generate the complete graph of the wireless mesh network, block 610 may further comprise identifying a message flow path through one or more relays nodes. For example, referring again to Table 1, the message from the transmitting node 0x8888 reaches the destination node 0x8001 following hops through two intermediate relay nodes, which are 0x00025b0145ba and 0x00025b011c10. In this example, the two intermediate relay nodes can be determined to be at different hop levels because the TTL value is reduced by one (1) in each hop. However, because the nodes neighboring node 0x8888 are only used to relay the mesh message, the device identifiers associated with the relay nodes are unknown. Nonetheless, as depicted in FIG. 7, a wireless mesh network graph 710 representing the wireless mesh network can be generated with the above-mentioned information and the relay nodes represented using the device address (ADDR) values.

Accordingly, referring to FIG. 7, knowing the network size, the transmitting node(s), and the message flow path may be sufficient to derive the topology shown in the wireless mesh network graph 710. Furthermore, this information along with the SRC identifier(s), the DST identifier(s), the device address(es), the TTL value(s), and the timestamp(s) associated with the captured message(s) may be helpful in identifying the nodes and the relative location of the nodes. For example, assuming that each node takes about the same time to process a message, the wireless mesh network graph 710 can be derived when T1<T2<T3<T4, where T1 is the timestamp of the message transmitted from source node 788, T2 is the timestamp of the message transmitted from relay node 702, T3 is the timestamp of the message transmitted from relay node 704, and T4 is the timestamp of the response message transmitted from destination node 701. Furthermore, when T3˜T5<T6 (T3 is approximately equal to T5), the relative location of additional nodes 706, 708 can be determined. Also given that T4<T7<T8, the messages transmitted at times T7, T8 confirm that the response message transmitted from destination node 701 to the source node 788 follow a message flow path that passes through relay node 704 and then relay node 702.

According to various aspects, referring to FIG. 6 in conjunction with FIG. 7, the wireless mesh network graph generated at block 610 (e.g., the wireless mesh network graph 710 as shown in FIG. 7) may be used to determine a redundant message flow. For example, in the wireless mesh network graph 710 as shown in FIG. 7, the transmitting source node 788 (0x8888) has selected a high TTL value (32), which results in nodes 706, 708 continuing to relay the message even after the message has already been received at the destination node 701. The high TTL value is the reason why nodes 706, 708 continue to relay the message, as messages that have a TTL value of two (2) or higher are relayed. Consequently, the same message may be received at the destination node 701 more than once. Although the nodes 788, 701, 702, 704, 706, 708 may each have a duplicate message cache, in a large wireless mesh network the duplicate message cache mechanism used to filter seen messages may eventually fail for the reasons discussed above, whereby the nodes 788, 701, 702, 704, 706, 708 may continue to process duplicate messages. As such, in various embodiments, an optimal TTL value for mesh network packets may be selected at block 620 in an effort to avoid unnecessary flooding due to redundant message flow. For example, FIG. 7 shows an optimized wireless mesh network graph 750 in which the transmitting source node 788 is configured to use a TTL value of four (4) when sending messages to destination node 701. In particular, as noted above, the TTL value may be decremented each time that a node receives and relays the message, wherein messages that have a TTL value of one (1) and zero (0) are not relayed. As such, even though node 706 may still receive the message from relay node 704, node 706 is omitted from the optimized wireless mesh network graph 750 because the packet received from the relay node 704 has a TTL value of two (2).

According to various aspects, at block 630, one or more selected relay nodes may be effectively disabled to eliminate or at least reduce redundant message flow. For example, as discussed in further detail below with reference to the following Table 2, the one or more selected relay nodes may be disabled at block 630 to optimize routing in the wireless mesh network based on a minimum number of nodes required to relay a message from one hop to the next hop.

TABLE 2
Example Mesh Network Log

| Time | ADDR | SRC | DST | MAC | TTL |
|---|---|---|---|---|---|
| T1 | 00025b014863 | 8888 | 8001 | d782f1367d1aa0e4 | 32 |
| T2 | 00025b0145ba | 8888 | 8001 | d782f1367d1aa0e4 | 31 |
| T3 | 00025b011c10 | 8888 | 8001 | d782f1367d1aa0e4 | 31 |
| T4 | 00025b001111 | 8001 | 8888 | 622685a564c152ee | 20 |
| T5 | 00025b011c10 | 8001 | 8888 | 622685a564c152ee | 19 |
| T6 | 00025b0145ba | 8001 | 8888 | 622685a564c152ee | 19 |

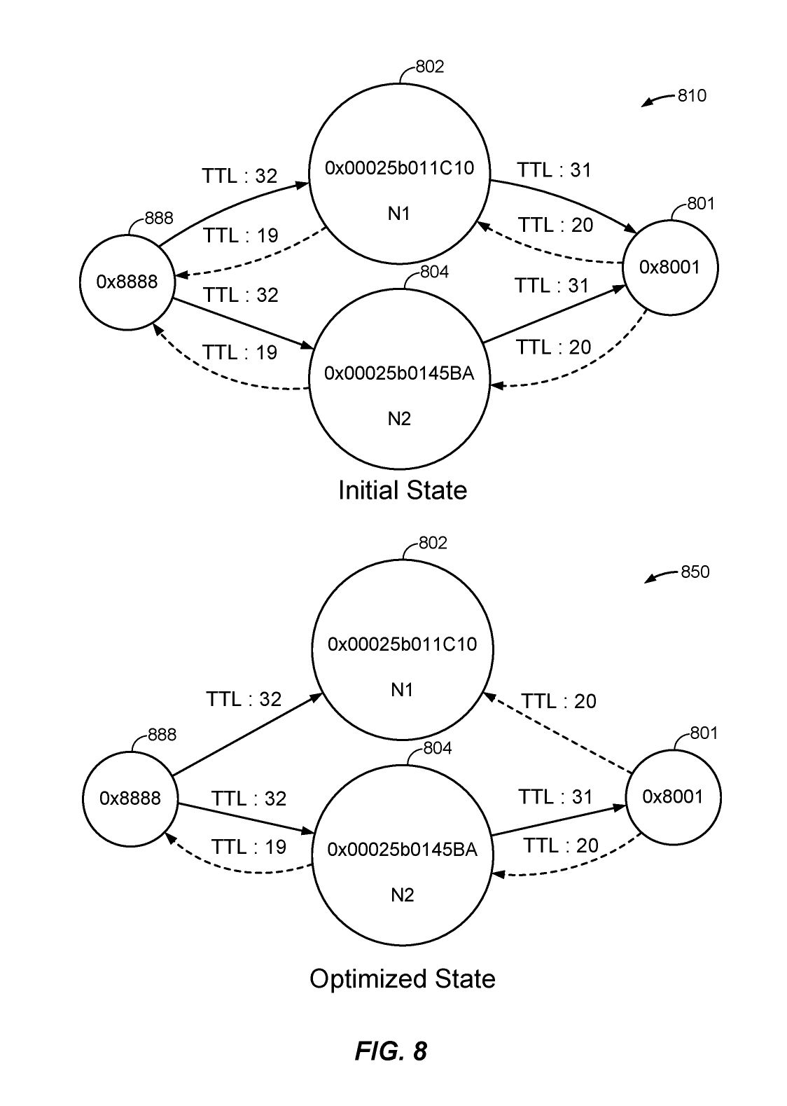

Referring to FIG. 8 and the example mesh network log shown in Table 2, a first graph 810 depicting an initial routing state in which a source node 888 originates the message having MAC value d782f1367d1aa0e4 with a TTL value of thirty-two (32). The original message is received at nodes 802, 804, which are each configured to the message with the TTL value decremented to thirty-one (31). As such, when two messages have the same MAC value and the same TTL value, the nodes transmitting the two messages can be determined to be located at the same hop level. Notably, the relay nodes 802, 804 both relay the message to the same destination node 801. Furthermore, a response message from the destination node 801 (i.e., the message having MAC value 622685a564c152ee) follows the same path except in reverse, in that the destination node 801 transmits the initial message with a TTL value of twenty (20) and the relay nodes 802, 804 both relay the response message to the original source node 888 with the TTL value decremented to nineteen (19). As shown in FIG. 8, the relay nodes 802, 804 are both present at the same hop level between the source node 888 and the destination node 801. Consequently, as mentioned above, the destination node 801 ends up receiving the same message from relay node 802 and relay node 804, and the source node 888 ends up receiving the same response message from relay node 802 and relay node 804, which reflects redundant message flow in the wireless mesh network.

Accordingly, in a wireless mesh network or a portion of a wireless mesh network having a topology as shown in FIG. 8, one or more relay nodes can be disabled at block 630 to eliminate or at least reduce the redundant message flow because the other neighboring node(s) between the transmitting source node 888 and the receiving destination node 801 is still available to rebroadcast or otherwise relay the message to the destination node 801. For example, FIG. 8 depicts a second graph 850 representing the same portion of the wireless mesh network as the first graph 810 except that the node 802 has been disabled as a relay node between the transmitting source node 888 and the receiving destination node 801 because the other node 804 is available to rebroadcast or otherwise relay messages communicated between nodes 888 and 801. Again assuming that each node takes approximately the same time to process a message, the graph 850 can be derived when T1<T2, T1<T3, and T2˜T3 (T2 is approximately equal to T3), where T1 is the timestamp of the message transmitted from the source node 888, T2 is the timestamp of the message relayed via intermediate node 802, and T3 is the timestamp of the message relayed via intermediate node 804.

The above optimization is described with reference to a particular use case in which there are two intermediate nodes 802, 804 arranged in such a way that there is a redundant message path between nodes 888 and 801. In various embodiments, however, the optimization described above may not be performed when there are only two intermediate relay nodes at a given hop level because leaving only one intermediate relay node could potentially lead to a bottleneck. Furthermore, the selected node(s) that have the relay function disabled may be checked for connectivity to other portions of the wireless mesh network to ensure that all nodes in the wireless mesh network remain well-connected. For example, in FIG. 8, node 802 may be optionally selected for disabling rather than node 804 based in part on node 804 having additional neighbor nodes and thus providing mesh connectivity in other parts of the network. Furthermore, disabling the relay at node 801 may result in fewer collisions over an advertising or broadcast channel for the neighbor node(s) 802, 804.

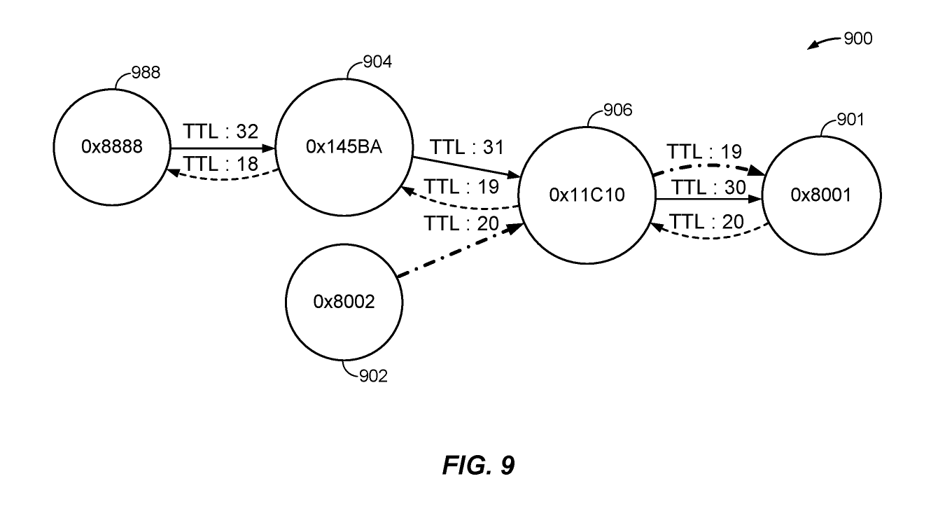

According to various aspects, referring again to FIG. 6, further optimizations may include detecting one or more critical nodes, detecting one or more non-functional nodes, and/or detecting one or more potential spamming nodes at block 640. With respect to critical node detection, delays in message transmissions can help to identify nodes that are located at junctions in the wireless mesh network and therefore exposed to substantial mesh network traffic. For example, with reference to FIG. 9, the example mesh network log shown in the following Table 3 may be used to derive a wireless mesh network graph 900 in which there are two source nodes 988, 902 with respective identifiers 0x8002, 0x8888, two relay nodes 904, 906 with respective destination addresses 0x00025b0145ba, 0x00025b011c10, and a destination node 901 with identifier 0x8001. Because relay node 906 relays messages from transmitting source node 988 and transmitting source node 902, relay node 906 can be considered to be a critical node.

TABLE 3
Example Mesh Network Log

| Time | ADDR | SRC | DST | MAC | TTL |
|---|---|---|---|---|---|
| T1 | 00025b014863 | 8888 | 8001 | d782f1367d1aa0e4 | 32 |
| T2 | 00025b0145ba | 8888 | 8001 | d782f1367d1aa0e4 | 31 |
| T3 | 00025b001111 | 8002 | 8001 | 54321987723491e1 | 20 |
| T4 | 00025b011c10 | 8002 | 8001 | 54321987723491e1 | 19 |
| T5 | 00025b011c10 | 8888 | 8001 | d782f1367d1aa0e4 | 30 |
| T6 | 00025b001111 | 8001 | 8888 | 622685a564c152ee | 20 |
| T7 | 00025b011c10 | 8001 | 8888 | 622685a564c152ee | 19 |
| T8 | 00025b0145ba | 8001 | 8888 | 622685a564c152ee | 18 |

According to various aspects, that relay node 906 is a critical node can also be confirmed through deriving message transmission delays within the portion of the wireless mesh network depicted in the graph 900. For example, assume that T1<T2<T3<T4<T5, where T1 is the timestamp of a first message (M1) transmitted from the first source node 988, T2 is the timestamp when relay node 904 transmits the message M1, T3 is the timestamp when the second source node 902 transmits a second message (M2), T4 is the timestamp when relay node 906 transmits the message M2, and T5 is the timestamp when relay node 906 transmits the message M1. Given the above assumptions, a difference between T2 and T1 may represent a delay associated with processing the message M1 in relay node 904, and a difference between T5 and T2 may represent a delay associated with processing the message M1 in relay node 906. When the first source node 988 and the second source node 902 both transmit messages, the difference between T5 and T2 could potentially be higher than the difference between T2 and T1 because the relay node 906 is busy processing messages from both source nodes 988, 902. Consequently, relay node 906 could potentially lose or drop packets if the processing load becomes excessive. Consequently, when the delay to relay a message through one node is longer than the delay to relay the same message through another node, the node that takes the longer time to relay the message may be considered a critical node. The increased delay to relay messages through a particular node may provide an indication that the node might be at a junction in the wireless mesh network such that the node has to process messages from various other nodes in the network. With more nodes talking to a critical node, the reliability of messages being relayed through the critical node may be reduced. In this manner, the load at the critical nodes may be monitored, controlled, etc. In another aspect, once the topology associated with the wireless mesh network is known, well-known techniques such as depth-first-search (DFS), breadth-first-search (BFS), etc. can be used to traverse the topology tree and identify nodes that have multiple children and/or parents but are alone in a hop level.

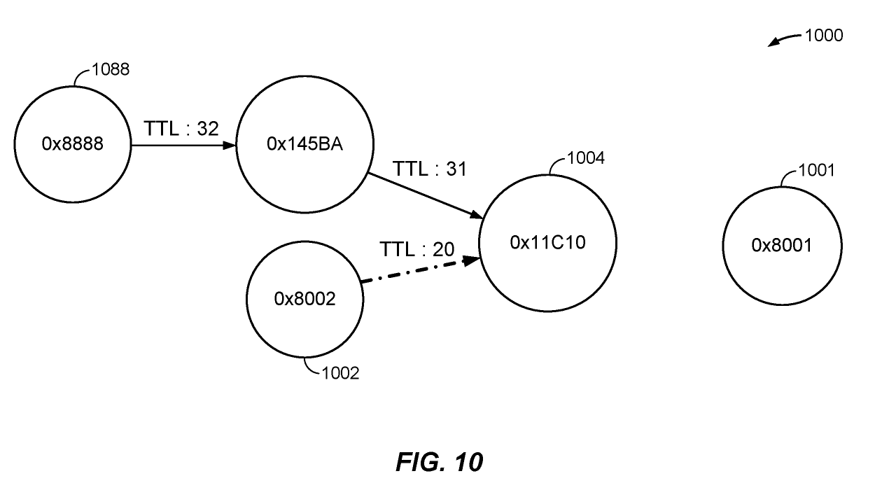

According to various aspects, as mentioned above, one or more non-functional nodes may also be detected at block 640. For example, with reference to FIG. 10, the example mesh network log shown in the following Table 4 may be used to derive a wireless mesh network graph 1000 in which node 1004 is not relaying messages that originated from source nodes 1088 and 1002 to node 1001, which could be the case because the node 1004 is busy processing messages from some other nodes or the node 1004 may have potentially ceased to function properly and entered a failure state.

TABLE 4
Example Mesh Network Log

| Time | ADDR | SRC | DST | MAC | TTL |
|---|---|---|---|---|---|
| T1 | 00025b014863 | 8888 | 8001 | d782f1367d1aa0e4 | 32 |
| T2 | 00025b0145ba | 8888 | 8001 | d782f1367d1aa0e4 | 31 |
| T3 | 00025b001111 | 8002 | 8001 | 54321987723491e1 | 20 |

According to various aspects, the failure of node 1004 to properly relay messages to node 1001 may be identified and diagnosed or otherwise debugged. For example, if another device (e.g., a mobile phone or another suitable controller device) can connect to the node 1004 and determine an increase in message count over a particular time period, an assumption can be made that the node 1004 has a healthy reception path but the transmission path may be non-functional. In another example, if the node 1004 can connect to the other device and the received message count is determined to not have increased over the time period, then an assumption can be made that both the reception and transmission paths are non-functional. In still another example, if the other device cannot connect to the node 1004 at all, then the node 1004 can be assumed to be completely non-functional. Furthermore, various statistics can be calculated based on the information in the mesh network logs and used to assess the number of nodes that each node is transmitting in the wireless mesh network over a given time period. From those statistics, information indicating nodes that are causing intentional and unintentional flooding in the wireless mesh network (i.e., spamming nodes) can be easily determined.

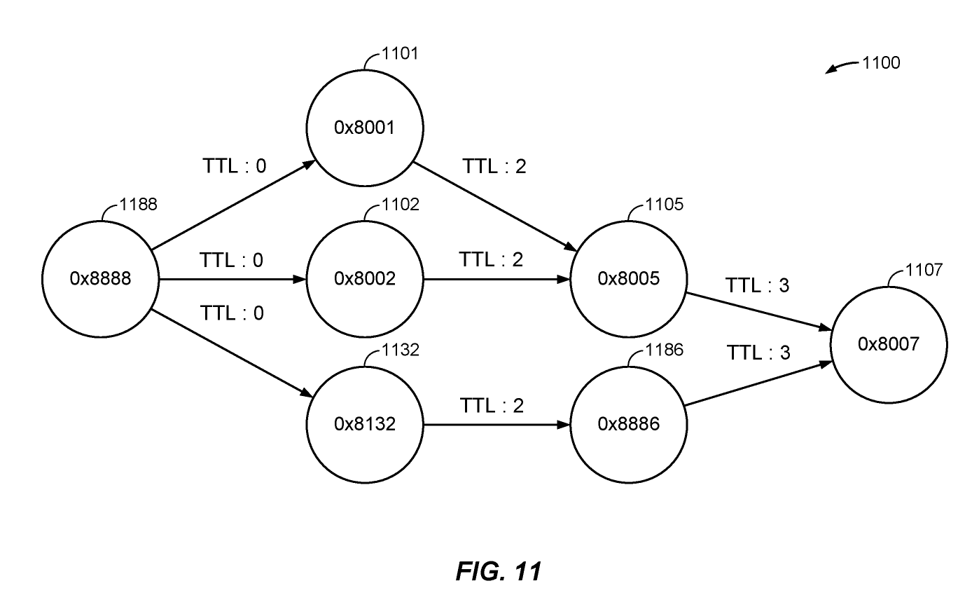

According to various aspects, referring again to FIG. 6, yet another optimization may include configuring one or more node-specific routing tables at block 650. For example, assuming that a given node has sufficient memory, a table specifying a TTL value to use when a particular node transmits a message to various destination nodes may be generated and provided to the node for storage in the memory. The table may be derived based on one or more mesh network logs including information associated with wireless mesh messages captured at one or more monitoring nodes, as discussed above. As such, once the number of nodes in the wireless mesh network or a portion thereof has been suitably determined along with the node(s) that a transmitting node is interested in communicating with, the optimal TTL value may be derived for each respective destination node. For example, with reference to the wireless mesh network graph 1100 as shown in FIG. 11, the following Table 5 shows an example node-specific routing table that may be stored at a node 1188 to configure a TTL value to use when communicating with various destination nodes 1101, 1102, 1132, 1105, 1186, and 1107. Accordingly, as shown below and in FIG. 11, a node may use a TTL value of zero (0) when transmitting messages to immediate neighbors 1101, 1102, 1132 because such messages do not need to be relayed. Furthermore, because messages that have a TTL value of zero (0) or one (1) are not forwarded, nodes 1105, 1186 located in a second hop (i.e., with one relay node in the message flow path) may be transmitted with a TTL value of two (2) to ensure that the message is only relayed at one hop level (i.e., the intermediate hop level). Similarly, node 1107 located in a third hop (i.e., with two relay nodes in the message flow path) may be transmitted with a TTL value of three (3) to ensure that the message is only relayed at the two hop levels needed to reach destination node 1107. With the help of the routing table, many other optimizations may also be possible. For example, among other possible optimizations, retransmission of a message to a particular destination node may be disabled based on the network topology, self-learning, and/or other information indicating that replies to the relay messages are not being received at the relay node(s).

TABLE 5
Example Node-Specific Routing Table

| Entry | ADDR | Neighbor Node | TTL |
|---|---|---|---|
| 1 | 00025b014863 | 8001 | 0 |
| 2 | 00025b0145ba | 8005 | 2 |
| 3 | 00025b011c10 | 8007 | 3 |
| 4 | 00025b001111 | 8886 | 2 |
| 5 | 00025b011b20 | 8132 | 0 |
| 6 | 00025b014211 | 8002 | 0 |

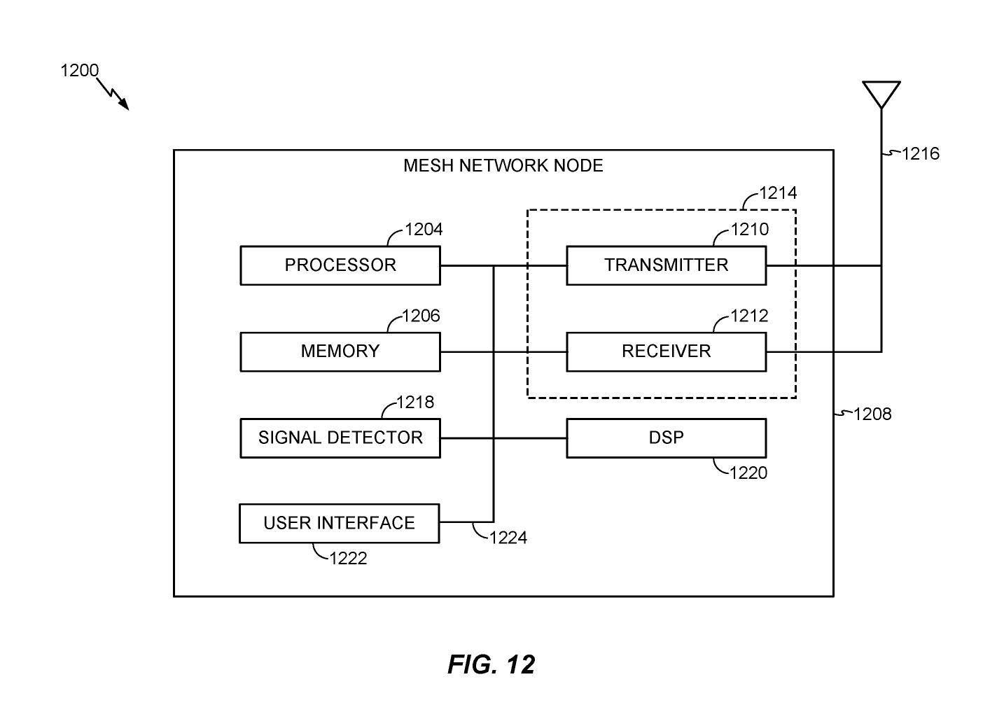

According to various aspects, FIG. 12 illustrates an exemplary wireless device 1200 that can be appropriately configured as a mesh network node in accordance with the various aspects and embodiments described herein. For example, the wireless device 1200 may correspond to any one or more of a monitoring node, a transmitting node, a relay node, a destination node, a critical node, a non-functional node, etc. that may be configured to communicate with other nodes in a wireless mesh network as described herein.

In various embodiments, the wireless device 1200 can include a processor 1204, a memory 1206, a housing 1208, a transmitter 1210, a receiver 1212, an antenna 1216, a signal detector 1218, a digital signal processor (DSP) 1220, a user interface 1222, and a bus system 1224. Alternatively, the functions of the transmitter 1210 and the receiver 1212 can be incorporated into a transceiver 1214. The wireless device 1200 can be configured to communicate in a wireless network that includes, for example, a base station (not illustrated), an access point (not illustrated), and the like.

In various embodiments, the processor 1204 can be configured to control operations of the wireless device 1200. The processor 1204 can also be referred to as a central processing unit (CPU). The memory 1206 can be coupled to the processor 1204, can be in communication with the processor 1204, and can provide instructions and data to the processor 1204. The processor 1204 can perform logical and arithmetic operations based on program instructions stored within the memory 1206. The instructions in the memory 1206 can be executable to perform one or more of the methods and processes described herein. In various embodiments, the processor 1204 can include, or be a component of, a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations and/or manipulate information. The processing system can also include machine-readable media for storing software. Software can be construed broadly to mean any type of instructions, whether referred to as software, firmware, middleware, microcode, hardware description language, or otherwise. Instructions can include code, e.g., in source code format, binary code format, executable code format, or any other suitable format of code. The instructions, when executed by the one or more processors, can cause the processing system to perform one or more of the functions described herein.

In various embodiments, the memory 1206 can include both read-only memory (ROM) and random access memory (RAM). A portion of the memory 1206 can also include non-volatile random access memory (NVRAM).

In various embodiments, the transmitter 1210 and the receiver 1212 (or the transceiver 1214) can allow transmission and reception of data between the wireless device 1200 and a remote location. The antenna 1216 can be attached to the housing 1208 and electrically coupled to the transceiver 1214. In some implementations, the wireless device 1200 can also include multiple transmitters, multiple receivers, multiple transceivers, and/or multiple antennas (not illustrated).

In various embodiments, the signal detector 1218 can be used to detect and quantify the level of signals received by the transceiver 1214. The signal detector 1218 can detect such signals as total energy, energy per subcarrier per symbol, and/or power spectral density and in other ways.

In various embodiments, the digital signal processor (DSP) 1220 can be used to process signals. The DSP 1220 can be configured to generate a packet for transmission. In some aspects, the packet can include a physical layer protocol data unit (PPDU).

In various embodiments, the user interface 1222 can include, for example, a keypad, a microphone, a speaker, and/or a display. The user interface 1222 can include any element or component that conveys information to a user of the wireless device 1200 and/or receives input from a user.

In various embodiments, the various components of the wireless device 1200 can be coupled together by a bus system 1224. The bus system 1224 can include a data bus, and can also include a power bus, a control signal bus, and/or a status signal bus in addition to the data bus.

In various embodiments, the wireless device 1200 can also include other components or elements not illustrated in FIG. 12. One or more of the components of the wireless device 1200 can be in communication with another one or more components of the wireless device 1200 by means of another communication channel (not illustrated) to provide, for example, an input signal to the other component.

Although a number of separate components are illustrated in FIG. 12, one or more of the components can be combined or commonly implemented. For example, the processor 1204 and the memory 1206 can be embodied on a single chip. The processor 1204 can additionally, or in the alternative, contain memory, such as processor registers. Similarly, one or more of the functional blocks or portions of the functionality of various blocks can be embodied on a single chip. Alternatively, the functionality of a particular block can be implemented on two or more chips. For example, the processor 1204 can be used to implement not only the functionality described above with respect to the processor 1204, but also to implement the functionality described above with respect to the signal detector 1218 and/or the DSP 1220.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects and embodiments described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences, and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of non-transitory computer-readable medium known in the art. An exemplary non-transitory computer-readable medium may be coupled to the processor such that the processor can read information from, and write information to, the non-transitory computer-readable medium. In the alternative, the non-transitory computer-readable medium may be integral to the processor. The processor and the non-transitory computer-readable medium may reside in an ASIC. The ASIC may reside in an IoT device. In the alternative, the processor and the non-transitory computer-readable medium may be discrete components in a user terminal.

In one or more exemplary aspects, the functions described herein may be implemented in hardware, software, firmware, or any combination thereof. If implemented in software, the functions may be stored on or transmitted over as one or more instructions or code on a non-transitory computer-readable medium. Computer-readable media may include storage media and/or communication media including any non-transitory medium that may facilitate transferring a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of a medium. The term disk and disc, which may be used interchangeably herein, includes CD, laser disc, optical disc, DVD, floppy disk, and Blu-ray discs, which usually reproduce data magnetically and/or optically with lasers. Combinations of the above should also be included within the scope of computer-readable media.

While the foregoing disclosure shows illustrative aspects and embodiments, those skilled in the art will appreciate that various changes and modifications could be made herein without departing from the scope of the disclosure as defined by the appended claims. Furthermore, in accordance with the various illustrative aspects and embodiments described herein, those skilled in the art will appreciate that the functions, steps, and/or actions in any methods described above and/or recited in any method claims appended hereto need not be performed in any particular order. Further still, to the extent that any elements are described above or recited in the appended claims in a singular form, those skilled in the art will appreciate that singular form(s) contemplate the plural as well unless limitation to the singular form(s) is explicitly stated.

What is claimed is:

1. A method for optimizing a wireless mesh network, comprising:
configuring one or more devices to be monitoring nodes in the wireless mesh network, wherein the monitoring nodes are selected from among a plurality of devices forming the wireless mesh network;
generating a graph representing a message flow path in at least a portion of the wireless mesh network, the message flow path determined based at least in part on information related to one or more messages observed at the monitoring nodes;
identifying, from the graph, at least one destination node and at least one source node that transmitted a message to the at least one destination node via one or more intermediate nodes; and
configuring a time-to-live (TTL) value to be used in messages communicated between the at least one source node and the at least one destination node, the TTL value based at least in part on a hop count between the at least one source node and the at least one destination node.

2. The method recited in claim 1, wherein configuring the one or more devices to be the monitoring nodes comprises:
identifying, among the plurality of devices forming the wireless mesh network, one or more stationary devices having the best radio range and processing capacity; and
selecting the one or more devices to be the monitoring nodes from among the identified one or more stationary devices according to a message count indicating that that the one or more selected devices are exposed to substantial mesh traffic.

3. The method recited in claim 1, wherein configuring the one or more devices to be the monitoring nodes comprises:
provisioning the monitoring nodes with a key used to encrypt and authenticate messages communicated in the wireless mesh network; and
causing the monitoring nodes to capture the information related to the one or more messages observed at the monitoring nodes using the provisioned key in a reference vicinity that includes at least the portion of the wireless mesh network.

4. The method recited in claim 1, wherein generating the graph representing the message flow path in at least the portion of the wireless mesh network comprises:
determining a number of nodes in the portion of the wireless mesh network based on a number of distinct device addresses associated with messages transmitted in the portion of the wireless mesh network;
identifying the at least one source node among multiple nodes that transmitted a message having a particular message access code (MAC), the at least one source node being one of the multiple nodes that transmitted the message using a largest TTL value; and
determining the message flow path between the at least one source node and the at least one destination node based on one or more nodes that relayed a message having the particular MAC and reduced the TTL value used in the relayed message.

5. The method recited in claim 4, wherein generating the graph representing the message flow path in at least the portion of the wireless mesh network further comprises determining relative locations of the one or more nodes that relayed the message having the particular MAC based on timestamps indicating when the one or more nodes relayed the message.

6. The method recited in claim 1, wherein each node that receives and relays the messages communicated between the at least one source node and the at least one destination node is configured to decrement the TTL value, and wherein messages with a TTL value of zero or one are not relayed such that the configured TTL value limits a number of times that the messages can be relayed in the wireless mesh network to the hop count between the at least one source node and the at least one destination node.

7. The method recited in claim 1, further comprising:
determining that the message flow path includes multiple intermediate nodes that are located at a same hop level between the at least one source node and the at least one destination node; and
disabling relay functionality at one or more of the multiple intermediate nodes.

8. The method recited in claim 7, wherein the one or more of the multiple intermediate nodes at which the relay functionality is disabled are determined based on one or more of connectivity to other portions of the wireless mesh network or a number of the multiple intermediate nodes that are located at the same hop level between the at least one source node and the at least one destination node.

9. The method recited in claim 1, further comprising determining one or more critical nodes in the portion of the wireless mesh network, wherein the one or more critical nodes are located at junctions that are exposed to substantial traffic in the portion of the wireless mesh network.

10. The method recited in claim 9, wherein the one or more critical nodes include a node that receives and relays messages originating from different source nodes.

11. The method recited in claim 9, wherein determining the one or more critical nodes comprises:
identifying at least a first intermediate node and a second intermediate node located in the message flow path between the at least one source node and the at least one destination node; and
including the second intermediate node among the one or more critical nodes in response to determining that the second intermediate node has a longer delay to process a message originating from the at least one source node than the first intermediate node.

12. The method recited in claim 9, wherein the one or more critical nodes include one or more of:
a node that is alone in a hop level and has one or more of multiple parent nodes or multiple child nodes, or
a node that has one or more child ones that are not reachable from one or more other nodes present in the hop level.

13. The method recited in claim 1, further comprising determining one or more non-functional nodes in the portion of the wireless mesh network, wherein the one or more non-functional nodes comprise nodes in the message flow path between the at least one source node and the at least one destination node that are not relaying messages originating from the at least one source node.

14. The method recited in claim 13, further comprising:
attempting to establish a point-to-point connection with at least one of the one or more non-functional nodes and to obtain a received message count from the at least one non-functional node via the point-to-point connection; and
diagnosing the at least one non-functional node, wherein diagnosing the at least one non-functional node comprises one of:
determining that the at least one non-functional node has entered a failure state in response to a failure to connect to the at least one non-functional node;
determining that the at least one non-functional node has non-functional reception and transmission paths in response to determining that the received message count has not increased over a defined time period; and
determining that the at least one non-functional node has a healthy reception path and a non-functional transmission path in response to determining that the received message count has increased over the defined time period.

15. A controller device for optimizing a wireless mesh network, comprising:
a transceiver configured to communicate via the wireless mesh network; and
a processor, coupled to the transceiver, and configured to:
configure, via the transceiver, one or more devices to be monitoring nodes in the wireless mesh network, wherein the monitoring nodes are selected from among a plurality of devices forming the wireless mesh network;
generate a graph representing a message flow path in at least a portion of the wireless mesh network, the message flow path determined based at least in part on information related to one or more messages observed at the monitoring nodes;
identify, from the graph, at least one destination node and at least one source node that transmitted a message to the at least one destination node via one or more intermediate nodes; and
configure, via the transceiver, a time-to-live (TTL) value to be used in messages communicated between the at least one source node and the at least one destination node based at least in part on a hop count between the at least one source node and the at least one destination node.

16. The controller device recited in claim 15, wherein the processor is further configured to:
identify, among the plurality of devices forming the wireless mesh network, one or more stationary devices having the best radio range and processing capacity; and
select the one or more devices to be the monitoring nodes from among the identified one or more stationary devices according to a message count indicating that that the one or more selected devices are exposed to substantial mesh traffic.

17. The controller device recited in claim 15, wherein the processor is further configured to:
provision the monitoring nodes with a key via the transceiver, the key used to encrypt and authenticate messages communicated in the wireless mesh network; and
cause the monitoring nodes to capture the information related to the one or more messages observed at the monitoring nodes using the provisioned key in a reference vicinity that includes at least the portion of the wireless mesh network.

18. The controller device recited in claim 15, wherein the processor is further configured to:
determine a number of nodes in the portion of the wireless mesh network based on a number of distinct device addresses associated with messages transmitted in the portion of the wireless mesh network;
identify the at least one source node among multiple nodes that transmitted a message having a particular message access code (MAC), the at least one source node being one of the multiple nodes that transmitted the message using a largest TTL value; and
determine the message flow path between the at least one source node and the at least one destination node based on one or more nodes that relayed a message having the particular MAC and reduced the TTL value used in the relayed message.

19. The controller device recited in claim 18, wherein the processor is further configured to determine relative locations of the one or more nodes that relayed the message having the particular MAC based on timestamps indicating when the one or more nodes relayed the message.

20. The controller device recited in claim 15, wherein each node that receives and relays the messages communicated between the at least one source node and the at least one destination node is configured to decrement the TTL value, and wherein messages with a TTL value of zero or one are not relayed such that the configured TTL value limits a number of times that the messages can be relayed in the wireless mesh network to the hop count between the at least one source node and the at least one destination node.

21. The controller device recited in claim 15, wherein the processor is further configured to:
determine that the message flow path includes multiple intermediate nodes that are located at a same hop level between the at least one source node and the at least one destination node; and
disable relay functionality at one or more of the multiple intermediate nodes.

22. The controller device recited in claim 21, wherein the processor is further configured to determine the one or more of the multiple intermediate nodes at which the relay functionality is disabled based on one or more of connectivity to other portions of the wireless mesh network or a number of the multiple intermediate nodes that are located at the same hop level between the at least one source node and the at least one destination node.

23. The controller device recited in claim 15, wherein the processor is further configured to determine one or more critical nodes in the portion of the wireless mesh network, the one or more critical nodes located at junctions that are exposed to substantial traffic in the portion of the wireless mesh network.

24. The controller device recited in claim 23, wherein the one or more critical nodes include a node that receives and relays messages originating from different source nodes.

25. The controller device recited in claim 23, wherein the processor is further configured to:
identify at least a first intermediate node and a second intermediate node located in the message flow path between the at least one source node and the at least one destination node; and
include the second intermediate node among the one or more critical nodes in response to that the second intermediate node having a longer delay to process a message originating from the at least one source node than the first intermediate node.

26. The controller device recited in claim 23, wherein the one or more critical nodes include one or more of:
a node that is alone in a hop level and has one or more of multiple parent nodes or multiple child nodes, or
a node that has one or more child ones that are not reachable from one or more other nodes present in the hop level.

27. The controller device recited in claim 15, wherein the processor is further configured to determine one or more non-functional nodes in the portion of the wireless mesh network, the one or more non-functional nodes comprising nodes in the message flow path between the at least one source node and the at least one destination node that are not relaying messages originating from the at least one source node.

28. The controller device recited in claim 27, wherein the processor is further configured to:
attempt to establish a point-to-point connection with at least one of the one or more non-functional nodes and to obtain a received message count from the at least one non-functional node via the point-to-point connection; and
determine a diagnosis for the at least one non-functional node, wherein the diagnosis comprises one of:
a determination that the at least one non-functional node has entered a failure state based on a failure to connect to the at least one non-functional node;
a determination that the at least one non-functional node has non-functional reception and transmission paths based on the received message count not having increased over a defined time period; and
a determination that the at least one non-functional node has a healthy reception path and a non-functional transmission path based on the received message count having increased over the defined time period.

29. An apparatus, comprising:
means for selecting one or more devices to be configured as monitoring nodes in a wireless mesh network from among a plurality of devices forming the wireless mesh network;
means for generating a graph representing a message flow path in at least a portion of the wireless mesh network, the message flow path determined based at least in part on information related to one or more messages observed at the monitoring nodes;
means for identifying, from the graph, a destination node and a source node that transmitted a message to the destination node via one or more intermediate nodes; and
means for configuring a time-to-live (TTL) value to be used in messages communicated between the source node and the destination node, the TTL value based at least in part on a hop count between the source node and the destination node.

30. A computer-readable medium storing computer-executable instructions, the stored computer-executable instructions configured to cause one or more processors to:
select one or more devices to be configured as monitoring nodes in a wireless mesh network from among a plurality of devices forming the wireless mesh network;
generate a graph representing a message flow path in at least a portion of the wireless mesh network, the message flow path determined based at least in part on information related to one or more messages observed at the monitoring nodes;
identify, from the graph, a destination node and a source node that transmitted a message to the destination node via one or more intermediate nodes; and
configure a time-to-live (TTL) value to be used in messages communicated between the source node and the destination node, the TTL value based at least in part on a hop count between the source node and the destination node.
